(19) United States
(12) Patent Application Publication
(10) Pub. No.: US 2026/0316368 A1
(43) Pub. Date: Oct. 15, 2026

(54) Apparatus and Associated Moulding Tools

(71) Applicant: kocher-plastik Maschinenbau GmbH, Sulzbach / Laufen (DE)

(72) Inventors: Michael Schultes, Fichtenau (DE); Patryk Prezyna, Karlsruhe (DE); Julian Feil, Abtsgmünd-Untergröningen (CH)

(73) Assignee: kocher-plastik Maschinenbau GmbH, Sulzbach / Laufen (DE)

(21) Appl. No.: 19/113,718

(22) PCT Filed: Feb. 12, 2024
(86) PCT No.: PCT/EP2024/053418

§ 371 Date: Mar. 20, 2025

(30) Foreign Application Priority Data
Apr. 11, 2023 (DE) 10 2023 001 403.6

(51) Int. Cl. B29C 49/04; B29C 49/42; B29C 49/48

(52) U.S. Cl. CPC B29C 49/04108; B29C 49/42809; B29C 49/4823; B29C 2049/4825; B29C 2049/4881; B29C 2049/4889

(57) ABSTRACT

The disclosure relates to producing plastic containers comprising a moulding unit which has at least one moulding tool with multiple moulding recesses specifying the contour and volume of the respective container, and comprising a production unit which supplies plasticised plastic material to the respective moulding tool by means of which the containers are formed and which has individual mandrels of a dispensing unit for filling with the fluid, which are each assigned to a moulding recess in a moulding tool, wherein the central longitudinal axes of adjacent mandrels have a predeterminable constant distance A from one another, to which a distance B between the individual adjacent moulding recesses of moulding tools, differing at least in terms of the size of their moulding recesses, is adapted as part of a parameterisation so that different container sizes can be produced with only one dispensing unit and one set of parameterised moulding tools.

### CROSS-REFERENCE TO RELATED APPLICATIONS

This application claims priority to German Patent Application DE 10 2023 001 403.6, filed on Apr. 11, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to an apparatus and associated moulding tools for producing plastic containers according to a blow moulding, filling and sealing process (BFS process), at least consisting of a moulding device, which has at least one moulding tool with a plurality of mould recesses which define the contour and volume of the respective container, and a production device which feeds plasticised plastic material to the respective moulding tool of the moulding device, by means of which the containers are moulded and can be sealed after filling with a fluid, and which has individual mandrels of a dispensing device for filling with the fluid, each of which mandrels is assigned to a mould recess in a moulding tool of the moulding device.

DE 10 2020 002 077 A1 discloses a method and associated apparatus for producing at least one container made of a plastic material which is filled with a medium, characterised by the following method steps:
Extrusion of a tube in a preform position by means of an extrusion device using supporting gas in the vertical extrusion direction,
Closing the tube at its lower end and cutting it off at its upper open end,
Transporting the parison, cut to length in this manner, by means of a gripper device in the linear transport direction transverse to the extrusion direction from the preform position into an open moulding tool,
Transferring the parison into the open moulding tool by means of the gripper device in a main moulding position,
Closing the moulding tool for the purpose of further moulding the parison by means of a pressure gradient,
Filling and sealing the parison, and
Transporting the gripper device back for a new sequence of the above travel steps.

WO 02/49821 A2 discloses a method for blow moulding, filling and sealing containers in which at least one tube of plasticised plastic material is extruded into an open mould. The tube is welded at its leading end by closing the mould. In addition, the tube is severed above the mould by means of a separating element to form a filling hole. The mould with the tube section located therein is then moved into a filling position where the container is formed in the mould by means of a blow mandrel and filled. After filling, the container is sealed while still in the mould. A corresponding apparatus is also disclosed.

WO 2020/201061 A1 discloses a blow moulding tool for a blow moulding machine for producing empty plastic containers in an extrusion or stretch blow moulding process which comprises two blow mould halves, each having at least one mould body in which at least one mould cavity is arranged, and a base plate receiving a mould body. An insulation block made of a thermally insulating material is arranged between the mould body and the base plate and, if necessary, further components of the blow mould half. In this way, the mass to be heated up or cooled down again should be significantly reduced and the associated heating up or cooling down is substantially only related to the mould body, so that in this way the associated energy input is reduced. The heatable and immediately coolable mould cavities, in the form of the mould recesses of the moulding tool, in conjunction with polished shaping wall surfaces of the mould cavities and the short cooling times, also enable the production of plastic containers with glossy surfaces.

With these and other known apparatus solutions, a separate moulding tool is created for each container size and, in the case of a BFS process, the specific filling or dispensing device with its individual blow and/or filling mandrels, referred to in the following as mandrels for short, is adapted to it. Inevitably, the number of mould recesses in the moulding tool and also the number of associated mandrels of the filling or dispensing device is then reduced accordingly for reasons of space in the case of correspondingly large-volume containers. Likewise, in view of high container output rates, the number of mould recesses in the moulding tool and the number of mandrels is increased if the container sizes are correspondingly small. Ultimately, this results in increased effort for the purposes of moulding tool construction and the construction of manufacturing apparatuses, as shown by way of example in DE 10 2020 002 077 A1.

### SUMMARY

A need exist to provide an improved solution to the effect that the effort involved in apparatus and moulding tool construction is reduced while providing output rates of finished containers comparable to prior art.

The need is addressed by the subject matter of the independent claim(s). Embodiments of the invention are described in the dependent claims, the following description, and the drawings.

### BRIEF DESCRIPTION OF THE DRAWINGS

FIG. 1 shows a perspective view of an example filling or dispensing device with eight mandrels and a mould half of an example moulding tool arranged underneath it according to the diagram shown in FIG. 3;

FIG. 2 shows a perspective diagram of an example moulding tool, consisting of two mould halves separated from each other which are composed substantially of three individual segments in each case;

FIGS. 3-5 shows a perspective view of one example mould half in each case of a moulding tool with container sizes of 100 ml, 250 ml and 500 ml; and

FIG. 6 shows a lateral view of an example container product, such as can be produced by a moulding tool according to the diagram shown in FIG. 3.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, it is provided that the central longitudinal axes of adjacent mandrels have a predefinable constant spacing dimension A from one another to which a spacing dimension B between the individual adjacent mould recesses of moulding tools, which differ from each other at least in the size of their mould recesses, is adjusted in the course of parameterisation, in such a manner that different container sizes can be produced with only one dispensing device and one set of parameterised moulding tools. In this way, filled containers of different sizes can be produced with only one filling or dispensing device with a predefinable number of mandrels and various moulding tools. For example, filling materials are liquids, but also emulsions or suspensions for medical purposes, such as infusion solutions, dialysis solutions or liquids for enteral nutrition.

It comes as a surprise to a person of ordinary skill in the art in the field of such moulding, filling and closing methods that, by parameterising the spacing dimensions as mentioned, a new machine standard and moulding tool standard is created which results in a significant reduction in the effort involved for producing filled containers, in particular filled and sealed bottles with a volume of 50 ml and more, particularly if, for example, the container shape/container size and thus the moulding tool has to be changed for the same filling material. This thus has no equivalent in prior art.

In the course of the parameterisation of the spacing dimensions mentioned, it has proven beneficial to provide between 6 and 10 cm, or for example between 7 and 8 cm, as a predefinable spacing dimension A for the mandrels of the dispensing device.

The moulding tools used within the apparatus have a plurality of moulding tools for producing different containers, in particular of different volumes, have the same spacing dimensions B, and a plurality of spacing dimensions B correspond to a predefinable spacing dimension A, which in the course of parameterisation arises as a grid dimension from the distance between adjacent central longitudinal axes of mandrels of a dispensing device.

It is for example provided in this case that the spacing dimension B for different moulding tools for producing containers of different volumes is implemented by different web widths S as a parameterising variable between adjacent mould recesses. It has been shown that a high surface quality and increased transparency of the containers can be achieved by appropriately selecting the respective web width S when using semi-crystalline plastics as the plastic material for the container products, in order to easily ensure visual, non-destructive inspection of finished containers, for example with regard to possible particulate contamination of the container and its contents. For this purpose, it is particularly beneficially provided that, for producing containers with nominal volumes of less than 1 litre, the parameterised web widths S are selected in the range from 10 to 40 mm, or for example from 10 to 35 mm, or for example from 10 to 33 mm. It has proven to be particularly beneficial for the parameterisation mentioned that, in order to maintain the predefinable grid or distance dimension A, which in technical terminology is also referred to as the cavity spacing and should for example be 75 mm, the individual web widths S are parameterised for a container volume of

100 ml at 28 mm-35 mm
250 ml at 23 mm-33 mm, and
500 ml at 12 mm-30 mm.

In some embodiments of the moulding tools according to the teachings herein, it is provided that they each consist substantially of two identical mould halves which, brought into alignment with each other, together define the respective mould recess, which is sealed towards a base end and open towards a head end. In this case, the respective mould half is for example composed of individual segments, with an individual segment for the head end and one for the base end as well as at least one intermediate individual segment with the mould recesses and the webs of predefinable width arranged therebetween, the parameterised web width S of which is kept constant within the individual segment. In this way, a modular system is created, consisting of a plurality of different individual segments which can be combined to form the respective moulding tool, so that a plurality of container sizes and container shapes can be covered with just a few basic components. In particular, identical individual segments can be used for the head end and the base end, provided that only the intermediate individual segments with the mould recesses are adapted to different container volumes. For example, for small container volumes, the axial installation length of the intermediate individual segments can be shorter than for large-volume containers, i.e. the container volume to be produced in each case is predefinable via the installation length of the mould recess or the cavity in the central individual segment, the longitudinal axis of the aforementioned respective mould recess extending in operation concentric with the longitudinal axis of the assignable mandrel of the filling or dispensing device, i.e. in this case the distance dimension B does not change despite the change in volume inside the moulding tools.

In some embodiments of the moulding tools, it is provided that the individual segments, in particular the respective individual segment with the mould recesses and the intermediate webs of parameterised width, consist of aluminium bronze, for example of beryllium-free aluminium bronze. With the aforementioned materials, it is possible to achieve higher thermal conductivities for the moulding tools compared to the materials otherwise used, such as aluminium, steel or non-ferrous materials, resulting in increased productivity for the BFS production process and good ability to inspect the container products.

To improve the surface quality for the containers, it can also for example be provided that the surface of the mould recesses of the moulding tools is polished.

Due to the standardisation of the individual segments for the moulding tools, it is also particularly easy to heat-control them evenly and provide them with connections for conducting a cooling medium.

In the course of overall parameterisation, it has also proven favourable from a productivity point of view if the respective moulding tool has 4 to 12, or for example 8, mould recesses as a further grid dimension.

Some embodiments relate to a system consisting of a set of moulding tools, wherein individual moulding tools are provided for producing plastic containers of different volumes, which have differently sized mould recesses which, in the course of parameterisation, all have the same spacing dimension B from one another, which corresponds to a predefinable spacing dimension A between the mandrels of a filling or dispensing device. Such a system makes it possible to use different moulding tools to produce container products with different volumes without making substantial modifications to the filling or dispensing device. Typical nominal filling volumes (in accordance with Section 6 of the German Weights and Measures Act, quantities which should be contained in the packaging) of such containers for infusion solutions are, for example, 50 ml, 100 ml, 250 ml and 500 ml. The total volume of these containers is always greater than the nominal filling volume, as a certain volume of air is also desired in the container. In the case of nominal filling volumes of 50 ml or more, the container is typically fully moulded in the moulding tool by blowing sterile air through the respective mandrel before filling.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS. The FIGS. are schematic and not necessarily to scale.

In the already cited prior art, tubes extruded from a tube die are introduced into a moulding tool by means of a gripper (DE 10 2020 002 077 A1) or are extruded directly into an open moulding tool.

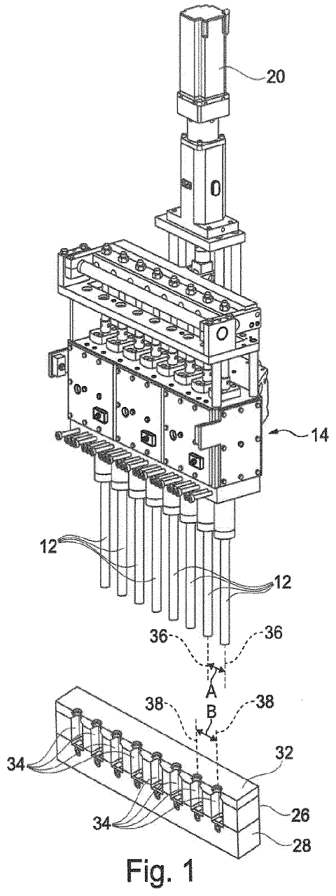

For the sake of simplicity, of the setup described above, FIG. 1 shows only the filling or dispensing device 14 with its individual blow-filling mandrels 12 which are used for blow moulding and dispensing the respective filling medium into a container body 18 of the container 16 to be produced in each case. The aforementioned dispensing device 14 can be moved up and down in a vertical direction by means of an actuator 20. In particular, the mandrels 12 can be moved back upwards in this way after the respective container body 18 has been filled, to enable a closing unit, which is not shown in greater detail, to seal the respective container product via a head part 22, which is to be moulded, that routinely connects integrally to the container body 18 via a neck part 24 (see FIG. 6). Closing units of this type are prior art, with the result that they will not be discussed in greater detail at this point.

In any case, for easier illustration and better comprehension, the corresponding plurality of additional components of an extrusion head or the moulding device is not shown.

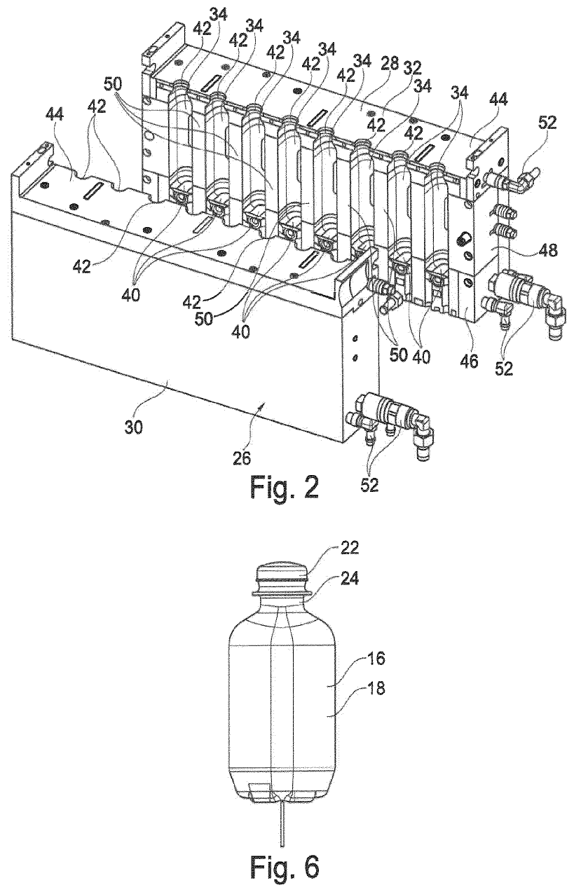

In the diagram of FIG. 1, a mould half 32 of the moulding tool 28 is shown below the filling or dispensing device 14, as shown in greater detail for a predefinable container size in FIG. 2. The correspondingly simplified diagram is only intended to illustrate that each mandrel 12 is assigned a mould recess 34 with the tube or container material introduced, whereby only half of the mould recesses 34 in the associated mould half 32 are shown in FIG. 1. The mould recess 34 as a whole, formed by the two closed mould halves 30, 32 as the respective moulding tool 28, are used in this case to produce the container and the plastic tube already mentioned, plasticised in each case by the extrusion head, passes into the assigned mould recesses 34 of the respective moulding tool 28 of the moulding device 26. The moulded tube is cut off at the head end, the container body 18 is moulded in the associated mould recess 34 by blow moulding and/or vacuum moulding by means of the attached mandrels and is filled with a predefinable medium, such as a liquid medicine, through the mandrel 12 of the filling or dispensing device 14. For this purpose, the filling or dispensing device 14 with its mandrels 12 is located in a lowered filling position using the actuator 20. Subsequently, the device 14 is moved back upwards in the opposite direction and the head is moulded and sealed, as described, by means of a closing unit which is not shown in greater detail. The finished container product created in this way leaves the moulding tool 28 as filled container 16, as shown by way of example in FIG. 6. Of course, other container geometries can also be produced easily here if necessary.

As FIG. 1 shows, the central longitudinal axes 36 of adjacent mandrels 12 have a predefinable constant spacing dimension A from one another. All filling mandrels 12 are hollow cylindrical and are concentric with their respective central longitudinal axis 36. For the sake of simplicity, the spacing dimension A is entered as a notional variable only for the two right-hand mandrels 12 viewed in the direction of FIG. 1. However, in this respect the spacing dimension A is constant between all adjacent mandrels 12. A spacing measurement B between the individual adjacent mould recesses 34 of moulding tools 28, which differ from each other at least in the size of their mould recesses 34, can be adjusted in the course of parameterisation to the spacing dimension A, in such a manner that different container sizes can be produced with only one dispensing device 14 and one set of parameterised moulding tools 28. According to the diagram shown in FIG. 1, the spacing dimension B corresponding to the spacing dimension A is formed in this case by the central longitudinal axes 38 of two adjacent mould recesses 34 of a moulding tool 28. In this respect too, the spacing dimension B, like the spacing dimension A, is a notional reference variable in the course of parameterisation. FIG. 1 shows only one half of the mould recesses 34; however, the spacing dimension relationship between A and B also applies to the complete mould recess 34 in each case, as soon as the mould halves 30, 32 are brought together to form a complete moulding tool 28. In this context, it has proven particularly beneficial to select the predefinable spacing dimension A between 6 cm and 10 cm, or for example between 7 cm and 8 cm.

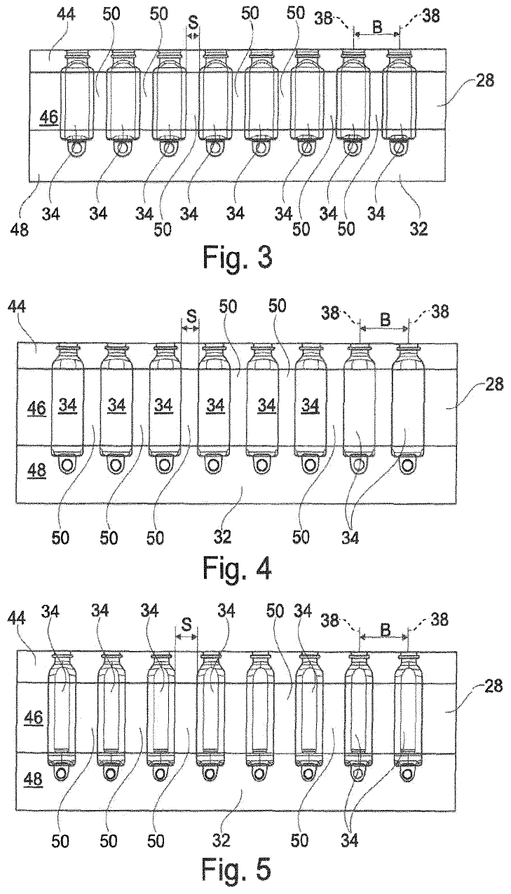

As can be seen in particular from FIGS. 3 to 5, all moulding tools 28 for different container volumes of, for example, 100 ml, 250 ml and 500 ml, have the same spacing dimension B which corresponds to the predefinable spacing dimension A shown in FIG. 1. The diagrams according to FIGS. 3 to 5 show a respective end view of the mould half 32 of the respective moulding tool 28 and the central longitudinal axes 36 of adjacent mould recesses 34 or mould recess halves are identical for all moulding tools 28 shown in FIGS. 3 to 5. In particular, the moulding tool 28 shown in FIG. 3 corresponds to the moulding tool 28 used according to FIG. 1, half of which is shown in each case. Accordingly, a plurality of moulding tools 28 for different containers 16 with different container volumes thus have one and the same spacing dimension B, which corresponds to the spacing dimension A, measured between the central longitudinal axes 38 of two adjacent mandrels 12 within a mandrel arrangement according to FIG. 1. In this way, the spacing dimension B results from the spacing A in the course of parameterisation.

The spacing dimension denoted by B, between the central longitudinal axes 38 of two adjacent mould recesses 34, is also referred to in technical terms as the cavity spacing and a cavity spacing B of 75 mm has proven to be particularly beneficial in the context of the implementation presented here. For easier illustration, in FIGS. 3 to 5, the respective central longitudinal axes 38 are also only entered for the two right-hand mould recesses 34; however, the relationships described apply in this respect to all mould recesses 34 of the moulding tools 28 shown in FIGS. 3 to 5, which are configured equidistantly in this respect.

To implement a constant spacing dimension B for different moulding tools 28 shown in FIGS. 3 to 5 for the purpose of producing containers 16 of different volumes, different web widths S are implemented as a parameterisation variable between adjacent mould recesses 34 for the moulding tools 28.

For example, the half of the moulding tool 28 shown according to FIG. 3 for producing containers 16 with a volume of 100 ml uses a value of 32.2 mm as the parameterisation variable or web width S, which is measured between adjacent wall parts of mutually adjacent mould recesses 34, as shown in FIG. 3. In this respect, too, the web width S for the embodiment according to FIG. 3 is identical for all mould recesses 34.

In the embodiment according to FIG. 4 for producing containers 16 with a volume of 250 ml, a value of 26.5 mm is selected as the web width S and consequently as the parameterisation variable, with a constantly maintained spacing dimension B which remains identical for all moulding tools 28 according to FIGS. 3 to 5, as already explained. In the embodiment of a moulding tool 28 according to FIG. 5 for producing a respective container volume of 500 ml, a value of 26.5 mm is likewise selected as the web width S, which corresponds to the web width S according to FIG. 4. Double the container volume of 500 ml in the solution according to FIG. 5 compared to half the container volume of 250 ml according to the diagram of FIG. 4 is obtained by the fact that the respective mould recess 34 is correspondingly extended in the axial direction, i.e. in concentric alignment with the respective central longitudinal axis 38. In this respect, too, the spacing dimension B is kept constant and adjusted to the spacing dimension A.

To sum up, parameterised web widths S ranging from 10 to 40 mm, or for example from 10 to 35 mm, or for example from 10 to 33 mm, result for containers 16 with volumes of less than 1 litre, as the embodiments according to FIGS. 3 to 5 illustrate.

In particular, to maintain a predefinable spacing measurement A, or for example 75 mm, for containers, in particular for infusion and irrigation solutions with a nominal filling volume of up to 500 ml, the individual web widths S are parameterised for a nominal container volume of

100 ml at 28 mm to 35 mm,
250 ml at 23 mm to 33 mm, and
500 ml at 12 mm to 30 mm.

If only containers with a nominal filling volume of up to 250 ml are to be produced with a set of moulding tools 28, a spacing distance A of for example 50 mm, with a web width S as the parameterisation variable of 10 mm to 20 mm.

As can also be seen in detail from FIG. 2, each moulding tool 28 basically consists of two identical mould halves 30, 32 which, brought into alignment with each other, together define the respective mould recess 34, which is sealed towards a base end 40 and open towards a head end 42. As further emerges from FIG. 2, the respective mould half 30, 32 is composed of individual segments 44, 46, 48 with an individual segment 44 for the head end and one 46 for the base end 40 and an intermediate individual segment 48 with the substantial part of the respective mould recess 34. Between adjacent mould recesses 34 in a row, there are individual webs 50 extending parallel to one another, the web width S of which is parameterised accordingly as shown in FIGS. 3 to 5 and is kept constant within the individual segment 46. In this respect, the webs 50 extend transverse to the longitudinal orientation of the respective individual segment 44, 46 and 48. As can further be seen from the diagram according to FIG. 2, the respective moulding tool 28 is provided with connections 52 which are not specified in greater detail and can be used to supply and discharge a cooling medium, in order to rapidly cool the plasticised plastic material introduced in the course of container production or to apply a vacuum in the respective mould recess 34, in order to ensure that the plastic material is applied cleanly to the mould walls of each mould recess 34.

As can be seen from FIGS. 3 to 5, in this way a system of individual moulding tools 28 is created which have differently sized mould recesses 34, which, however, in the course of the parameterisation, all have the same spacing dimension B from one another, which corresponds to a predefinable spacing dimension A between adjacent mandrels 12 of a dispensing device 14. In this respect, routinely in the course of the parameterisation mentioned, the moulding tools 28 only differ substantially in the predefinable web width S for the individual webs 50 of each moulding tool 28.

To ensure that the spacing dimensions B and the associated parameterisation of the web widths S are sensibly maintained, it has proven beneficial to provide a total of eight mandrels 12 and eight mould recesses 34 in each moulding tool 28 as part of a rapid production sequence. This results in high output rates of finished containers 16.

For easier illustration, all diagrams of moulding tools 28 are shown without the associated moulding devices for producing the head part 22 for the respective container 16. Corresponding head moulding devices are common, with the result that they will not be discussed in greater detail at this point.

Suitable plastics for the production process according to the teachings herein and as container material include semi-crystalline polyolefins, such as polyethylene (PE), in particular low-density polyethylene (LDPE), high-density polyethylene (HDPE) and polypropylene (PP). Blends of semi-crystalline polyolefins with amorphous polyolefins, such as cyclic olefin polymers (COP) and cyclic olefin copolymers (COC) can also be processed beneficially. Accordingly, containers 16 can also be produced, as in DE 10 347 908 A1, with a corresponding multi-layer structure for the container wall.

As a specific embodiment, one-piece infusion containers 16 with four different nominal volumes (100 ml, 250 ml, 500 ml and 1000 ml) made of different PP and PE materials with an average wall thickness of 0.35-0.52 mm are produced using a bp 321 bottlepack system by rommelag, Waiblingen, Germany, filled with water and sealed according to the blow-moulding, filling and sealing or closing process. The materials used were: LyondellBasell RP 270G; Borealis SB 815 MO, Flint Hills Rexene 23M2A and LDPE: LyondellBasell Purell 3020D and 3220D. For this purpose, moulding tools 28 with eight cavities or mould recesses 34 made of different materials and with different web widths S of the webs 50 from 20 mm to 50 mm were used. The respective mould recesses 34 were cooled accordingly in the course of plastic container production by supplying a suitable cooling medium via some of the connections 52. The container shape of a container 16 shown in FIG. 6 and produced with the apparatus according to the teachings herein corresponds to a container solution as illustrated in FIGS. 1 and 2 of DE 10 2016 002 467 A1.

The filled container bodies 18 were also sterilised by heat treatment (autoclaving).

The optical quality (transparency) of the various containers 16 was determined in a similar way to ASTM D1003-11. The overall transmission, haze and clarity, surface gloss and colour all have an influence on transparency. The haze-gard plus measuring device by BYK Gardner GmbH, 82538 Geretsried, was used to determine the transmission, haze and clarity value for the individual BFS containers 16. This device measures the transmission at an optical wavelength of 550-650 mm. At the measuring point, the wall thickness of the container 16 was approx. 0.45 mm.

The best results were obtained with containers 16 and web widths S between 10 and 40 mm, or for example between 10 and 35 mm, or for example between 10 and 33 mm, in particular if the moulding tools 28 with their mould recesses 34 were made of copper alloys containing beryllium, the beryllium content of which is typically between 0.5% and 3%. For example, however, moulding tools 28 made of beryllium-free (beryllium content less than 0.3%) aluminium bronzes with an aluminium content between 8% and 16% are used, although their thermal conductivity at 20° C. is significantly less than 100 W/(m*K).

Despite temperature-controlled moulding tools 28, the web width S—and thus the thermal capacity immediately available for cooling the heat-softened plastic—plays a decisive role in the crystallisation behaviour (nucleation and crystal growth) of the plastics used. In particular, this is the case when using moulding tools 28 made of aluminium bronzes. For the transparency behaviour of the respective container 16, it has proven favourable to polish the walls of the mould recesses 34 of each moulding tool 28.

In this way, an apparatus is created for cost-effectively producing containers 16, in particular for filling fluids for medical purposes according to the BFS process, with which, when using semi-crystalline plastics, an improved surface quality and increased transparency of the containers 16 can be achieved via a meaningful parameterisation of the web width S and thus a visual, non-destructive inspection, for example with regard to particulate contamination of containers 16 and container contents, is facilitated.

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-15. (canceled)

16. An apparatus for producing plastic containers according to a blow moulding, filling and sealing process, at least comprising:
a moulding device, which has at least one moulding tool with a plurality of mould recesses which define the contour and volume of the respective container; and
a production device which feeds plasticised plastic material to the respective moulding tool of the moulding device, by means of which the containers are moulded and can be sealed after filling with a fluid, and which has individual mandrels of a dispensing device for filling with the fluid, each of which mandrels is assigned to a mould recess in a moulding tool of the moulding device; wherein
the central longitudinal axes of adjacent mandrels have a predefinable constant spacing dimension A from one another, to which a spacing dimension B between the individual adjacent mould recesses of moulding tools, which differ from each other at least in the size of their mould recesses, is adjusted in the course of parameterisation, in such a manner that different container sizes can be produced with only one dispensing device and one set of parameterised moulding tools.

17. The apparatus of claim 16, wherein the predefinable spacing dimension A is between 5 cm and 10 cm, or between 5 cm and 8 cm.

18. Moulding tools for producing containers of different volumes, wherein a plurality thereof have same spacing dimensions B and wherein a plurality of spacing dimensions B correspond to a predefinable spacing dimension A which results in the course of parameterisation from a spacing between mutually adjacent central longitudinal axes of mandrels of a dispensing device.

19. The moulding tools of claim 18, wherein the spacing dimension B for producing containers of different volumes is implemented by different web widths S as a parameterising variable between adjacent mould recesses.

20. The moulding tools of claim 18 for producing containers with nominal filling volumes of up to 1 litre, wherein the parameterised web widths S are selected in the range from 10 to 40 mm, or from 10 to 35 mm, or from 10 to 33 mm.

21. The moulding tools of claim 18, wherein to maintain a predefinable spacing dimension A, the individual web widths S are parameterised for a nominal container volume of:
100 ml at 28 mm-35 mm
250 ml at 23 mm-33 mm, and
500 ml at 12 mm-30 mm.

22. The moulding tools of claim 18, wherein the moulding tools each consist substantially of two identical mould halves which, brought into alignment with each other, together define the respective mould recess, which is sealed towards a base end (40) and open towards a head end.

23. The moulding tools of claim 18, wherein the respective mould half is composed of individual segments, with an individual segment for the head end and one for the base end as well as an intermediate individual segment with the mould recesses and the webs of predefinable width arranged therebetween, the parameterised web width S of which is kept constant within the individual segment.

24. The moulding tools of claim 18, wherein the individual segments, in particular the respective individual segment with the mould recesses and the webs of parameterised width S therebetween, consist of aluminium bronze, for example of beryllium-free aluminium bronze.

25. The moulding tools of claim 18, wherein the surface of the mould recesses is polished.

26. The moulding tools of claim 18, wherein the moulding tools can be temperature controlled and/or have connections for conducting a cooling medium.

27. The moulding tools of claim 18, wherein the moulding tools each have 4 to 12, or 8 mould recesses.

28. A system, consisting of a set of individual moulding tools, wherein individual moulding tools are provided for producing plastic containers of different volumes, which have differently sized mould recesses which, in the course of parameterisation, all have a same spacing dimension B from one another, which corresponds to a predefinable spacing dimension A between adjacent mandrels of a dispensing device.

29. The system of claim 28, comprising at least two moulding tools with which plastic containers, in particular for medical purposes, such as for infusion and/or irrigation, can be produced with a nominal filling volume of 500 ml and 250 ml.

30. The system of claim 28, comprising at least two moulding tools with which plastic containers, in particular for medical purposes, such as for infusion and/or irrigation, can be produced with a nominal filling volume of 250 ml and 100 ml.

31. The moulding tools of claim 16, adapted for the apparatus of claim 1.

32. The moulding tools of claim 19, for producing containers with nominal filling volumes of up to 1 litre, wherein the parameterised web widths S are selected in the range from 10 to 40 mm, or from 10 to 35 mm, or from 10 to 33 mm.

33. The moulding tools of claim 19, wherein to maintain a predefinable spacing dimension A, the individual web widths S are parameterised for a nominal container volume of:
100 ml at 28 mm-35 mm
250 ml at 23 mm-33 mm, and
500 ml at 12 mm-30 mm.

34. The moulding tools of claim 20, wherein to maintain a predefinable spacing dimension A, the individual web widths S are parameterised for a nominal container volume of:
100 ml at 28 mm-35 mm
250 ml at 23 mm-33 mm, and
500 ml at 12 mm-30 mm.

35. The moulding tools of claim 19, wherein the moulding tools each consist substantially of two identical mould halves which, brought into alignment with each other, together define the respective mould recess, which is sealed towards a base end (40) and open towards a head end.
